(19) United States
(12) Patent Application Publication
(10) Pub. No.: US 2006/0142046 A1
(43) Pub. Date: Jun. 29, 2006

(54) Interactive system associated with electronic equipment

(76) Inventor: Ziad Badarneh, Oslo (NO)

Correspondence Address: BELL, BOYD & LLOYD, LLC, P. O. BOX 1135, CHICAGO, IL, 60690-1135, US

(21) Appl. No.: 10/545,035

(22) PCT Filed: Jan. 28, 2004
(86) PCT No.: PCT/EP04/00757

§ 371 Date: Aug. 11, 2005

(30) Foreign Application Priority Data
Feb. 14, 2003 (DE) 103 321.8

(51) Int. Cl. H04M 1/00

(52) U.S. Cl. 455/550.1

(57) ABSTRACT

The aim of the present disclosure is to develop a digit input functionality. For this purpose, a navigation input element designed for other purpose is used from now on.

### FIELD OF TECHNOLOGY

The present disclosure relates to an input device and a communication unit, in particular a mobile telephone, a cordless telephone or a portable computer, having a navigation-input element.

### BACKGROUND

Rapid technological developments in the field of mobile communication have in recent years led to progressive miniaturization of the terminals employed therein.

This miniaturization is attended and not just in the field of mobile communication by problems of operating convenience, since the small housing surfaces of the miniaturized terminals hinder the incorporation of additional numbers of buttons commensurate with the devices' range of functions.

Known solutions to this problem provide either for ever-increasing multiple assignment of buttons, for a voice control means, or, as a button supplement, for an input wheel enabling different information to be entered by scrolling selectable characters across a display area.

It is further known from European patent application EP 1071006 A2 how to use a navigation-input element and what is termed a softkey for entering information into an electronic device. For entering information via a softkey, a mechanical input element, for example a button, is as a rule assigned a display area located in the vicinity of said button. Depending on the operating status, various display-control elements assigned control functions are displayed in this defined display area. The control function assigned to the momentarily shown display-control element will then be triggered when the input element is actuated.

### BRIEF SUMMARY

In light of the above, a configuration is disclosed for using a navigation-input element, while allowing a further reduction in the relevant device's housing surface required for an input device.

According to the present disclosure, a digit-input functionality is realized by the navigation input element, where it will consequently be possible to economize on the housing area otherwise provided for the key field for realizing the digit-input functionality. However, both the hardware expenditure for said key field and that entailed in its production will no longer apply.

An input device can herein in particular also be a man-machine interface, referred to also as a control device.

The input device disclosed herein includes a processor device or may be controlled by a processor device.

The navigation-input element can be a mechanical toggle element, in particular a key element embodied in a planar fashion or a control lever, either of which can be toggled in several toggle directions and is elastically borne in such a way that after a toggle action it will automatically be moved back into a rest position.

### BRIEF DESCRIPTION OF THE DRAWINGS

The various objects, advantages and novel features of the present disclosure will be more readily apprehended from the following Detailed Description when read in conjunction with the enclosed drawings, in which:

FIG. 1 is a block diagram of a mobile station having a control device according to an exemplary embodiment;

FIG. 2 is a schematic of a digit input under the disclosed embodiment; and

FIG. 3 is a schematic of a character input under the disclosed embodiment.

### DETAILED DESCRIPTION

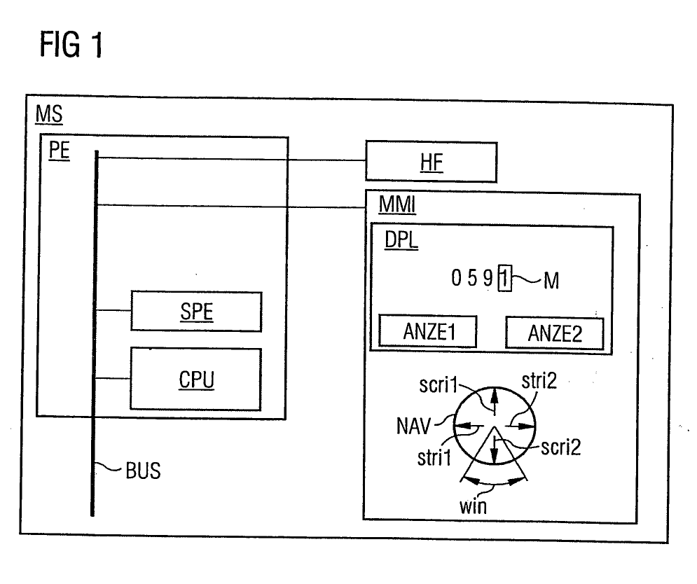

FIG. 1 illustrates a mobile station MS, preferably a mobile telephone, containing a control device MMI, a high-frequency device HF, and a processor device PE. Control device MMI includes a display unit DPL such as, for instance, a graphic display, and a navigation-input element NAV.

A program-controlled processor device PE, such as a microcontroller, which can also include a processor CPU and a storage device SPE, is provided for controlling the mobile station MS and particularly the control device MMI. The program data such as the control instructions or control procedures used for controlling the mobile station and the control device MMI, as well as information for assigning between control-display elements, control functions, and toggle directions, is also stored in the storage device SPE.

The various components of the processor device can exchange data with each other or with further components of the mobile station via a bus system BUS or via input/output interfaces and, where applicable, via suitable controllers. A person skilled in the relevant art is adequately aware of how in programming terms to appropriately set up these and further components of a processor device, and hence the processor device itself, for controlling a mobile station or, as the case may be, a control device and for realizing specific functions and applications of the mobile station.

The processor device can herein be realized, for example, also by means of a chip set, which can have a plurality of processors, that has been specially produced for controlling a control device or mobile station.

Control functions or, as the case may be, a character in a character set are selected or digits or, as the case may be, character sets are selected by means of the navigation-input element NAV that can be preferably toggled in four toggle directions.

The round navigation-input element preferably has a flat profile and can be toggled from its rest position in particular in two digit-selection directions (in the digit-input mode) pointing in opposite directions or, as the case may be, character-set-selection directions (in the character-input mode) pointing in opposite directions scri1, scri2 and in two control directions pointing in opposite directions stri1, stri2. The axis defined by the digit-selection directions or, as the case may be, character-set-selection directions is therein perpendicular to that defined by the control directions.

It is noted that the above description does not preclude the navigation-input element's being togglable in any direction pointing from the center of the navigation-input element toward the edge of the navigation-input element.

Toggling of the navigation-input element in a digit-selection direction or, as the case may be, character-set-selection direction, or in a control direction herein also includes toggling of the navigation-input element in a direction within a delimited angular range win around the respective direction (shown by way of example for scri2).

Through toggling of the navigation-input element in a first control direction stri1, a control function will be triggered that is assigned to the first control-display element ANZE1. Through toggling of the navigation-input element in a second control direction stri2, a control function will be triggered that is assigned to the second control-display element ANZE2.

The control-display elements shown can change depending on the current operating status of the mobile station or on the current menu level. This means that different control functions can be triggered through toggling of the navigation-input element in a control direction depending on the current operating status of the mobile station or on the current menu level.

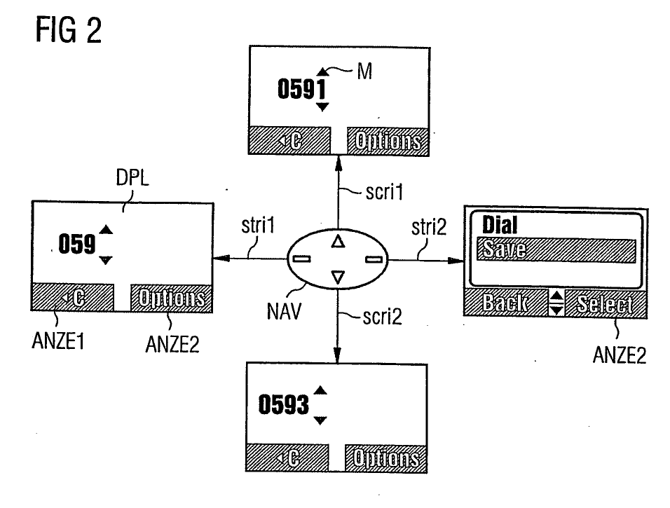

An example for entering digits is described below by way of example with the aid of FIG. 2.

The digit-input control function will be triggered when the navigation-input element has been toggled in a first control direction as the result of which the mobile station will be switched to a digit-input operating mode in which the directory number requiring to be called is entered.

Through toggling of the navigation-input element in one of the two digit-selection directions scri1, scri2 the elements of the digit sequence 0 to 9 that can be entered will be shifted or, as the case may be, scrolled by the marker M in accordance with the selected digit-selection direction.

The digit momentarily marked by the marker M will be deemed entered when the navigation-input element remains in its rest position for longer than a predefined period of time. The part of the directory number “059” already entered up to that point will be shifted one digit position to the left or the marker M will be shifted one position to the right.

Through toggling of the navigation-input element in the first control direction stri1, the digit last entered or that to the left of the marker will be deleted. This deletion-control function corresponds to the first control-display element ANZEL shown by the letter “C” in the bottom left quadrant of the display DPL.

Through toggling of the navigation-input element in the second control direction stri2, the option-activating control function will be triggered and the option “Dial” or, as the case may be, “Save” shown, through selecting which the dial-control function or, as the case may be, storage-control function will be triggered. Said option-activating control function corresponds to the second control-display element ANZE2 shown by the word “Options” in the bottom right quadrant of the display DPL.

It is possible to select between the two options by a scrolling action triggered by toggling in one of the two digit-selection directions. Once chosen, an option can be selected by toggling the navigation-input element in the second control direction stri2. This selecting corresponds to the second control-display element ANZE2 “Select” then shown in the bottom right quadrant of the display DPL.

Through toggling of the navigation-input element in the first control direction stri1, a swift return (“Back”) to the digit-input mode will be triggered.

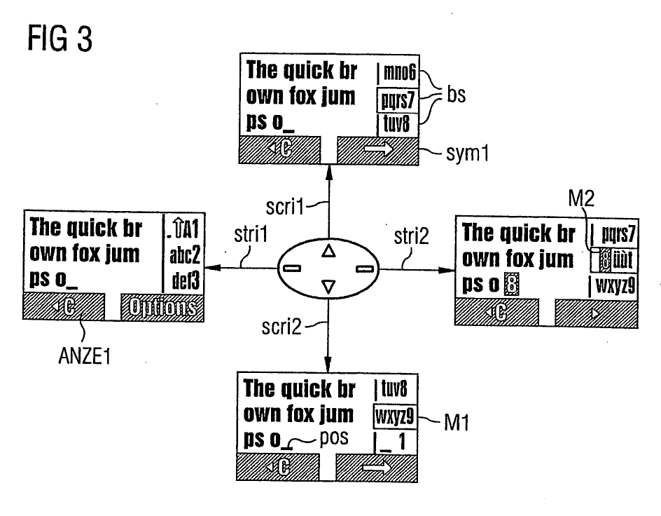

An example for entering characters is described below by way of example with the aid of FIG. 3.

The character-input control function will be triggered when the navigation-input element has been toggled in a first control direction as the result of which the mobile station will be switched to a character-input operating mode in which character sequences are entered.

Through toggling of the navigation-input element in one of the two character-set-selection directions scri1, scri2, character sets bs will be shifted or, as the case may be, scrolled by the first marker M1 in particular in accordance with the selected character-set-selection direction.

The character set “8üùt” momentarily marked by the first marker M1 will be deemed selected when the navigation-input element remains in its rest position for longer than a predefined period of time.

Through ensuing toggling of the navigation-input element in the second control direction stri2, the character-selection control function will be triggered which is assigned to the arrow symbol sym1.

Through ensuing toggling of the navigation-input element in the second control direction stri2 a second marker M2 will be shifted across characters in the selected character set.

The character “8” momentarily marked by the second marker M2 will be deemed selected when the navigation-input element remains in its rest position for longer than a predefined period of time and will be inserted at the marked position pos in the previously entered text.

Through toggling of the navigation-input element in the first control direction stri1, the character last entered or that to the left of the marked position pos will be deleted. This deletion-control function corresponds to the first control-display element ANZE1 shown by the letter “C” in the bottom left quadrant of the display DPL.

It should be understood that various changes and modifications to the presently preferred embodiments described herein will be apparent to those skilled in the art. Such changes and modifications can be made without departing from the spirit and scope of the present disclosure and without diminishing its intended advantages. It is therefore intended that such changes and modifications be covered by the appended claims.

1-15. (canceled)

16. An input device, comprising:
a display device; and
a navigation input element, coupled to the display device, wherein the input element comprises a toggle that has movement in at least four directions and wherein each direction enables two digit selection directions and two control directions, and a digit is selected by toggling the navigation input element in one of the two digit selection directions, and wherein:
a plurality of control display elements are assigned a respective control function, in the toggle;
each control direction is assigned a defined position on the display device, and by toggling the navigation input element in one of the control directions, the respective control function is triggered.

17. The input device according to claim 16, wherein character input functionality is realized by the navigation input element.

18. The input device according to claim 16 wherein the toggling of the navigation input element in a digit selection direction triggers cyclic scrolling of the selectable digits in the direction corresponding to the digit selection direction.

19. The input device according to claim 16, wherein scrolling is enabled through the digits in a digit sequence being shifted individually by a marker or through a marker being shifted across digits in a digit sequence, and in which the digit marked for a predefined period of time by a marker will be deemed entered.

20. The input device according to claim 16, wherein the at least four toggle directions includes a first control direction and a second control direction, wherein, toggling in the first control direction, the character to the left of the marker will be deleted.

21. The input device according to claim 20, wherein the at least four toggle directions includes a first control direction and a second control direction, wherein, through toggling in the second control direction, options are displayed.

22. The input device according to claim 21, wherein a dial function or a storage function can be selected by means of the options.

23. The input device according to claim 16, wherein the at least four toggle directions comprise two character-set selection directions and two control directions, and through toggling of the navigation input element in one of the two character set selection directions, a character set can be selected.

24. The input device according to claim 23, wherein a plurality of control display elements are each assigned a control function, and wherein each control direction is assigned a defined position on the display device, and wherein the navigation input element in one of the two control directions, the respective control function is triggered.

25. The input device according to claim 23, wherein after a character set has been selected through toggling of the navigation input element in one of the two control directions, a character can be selected from the character set.

26. The input device according to claim 23, wherein after a character set has been selected through toggling of the navigation input element in a control direction, scrolling of the characters that can be selected from the selected character set will be triggered in the direction corresponding to the control direction.

27. The input device according to claim 26, wherein scrolling is enabled through the characters in the selected character set being shifted across characters in the selected character set, and wherein the character marked for a predefined period of time by a marker will be deemed entered.

28. The input device according to claim 17, wherein the digit selection directions are identical to the character set selection directions.

29. The input device according to claim 16, wherein the input device is incorporated in a communication unit.
